(19) United States
(12) Patent Application Publication
(10) Pub. No.: US 2018/0358658 A1
(43) Pub. Date: Dec. 13, 2018

(54) ELECTROCHEMICAL CELL FOR A LITHIUM BATTERY, COMPRISING A SPECIFIC ELECTROLYTE

(71) Applicant: COMMISSARIAT A L'ENERGIE ATOMIQUE ET AUX ENERGIES ALTERNATIVES, Paris (FR)

(72) Inventors: Thibaut Gutel, Veurey Voroize (FR); Laura Boutafa, Echirolles (FR); Daniel Tomasi, Villard Saint Christophe (FR)

(21) Appl. No.: 16/060,149

(22) PCT Filed: Dec. 6, 2016
(86) PCT No.: PCT/EP2016/079897

§ 371 Date: Jun. 7, 2018

(30) Foreign Application Priority Data
Dec. 8, 2015 (FR) 15 62013

(51) Int. Cl. H01M 10/0569; H01M 10/052; H01M 10/0568; H01M 4/36; H01M 4/38; H01M 4/587

(52) U.S. Cl. CPC H01M 10/0569; H01M 10/052; H01M 10/0568; H01M 2300/0028; H01M 4/386; H01M 4/587; H01M 4/382; H01M 4/364

(57) ABSTRACT

An electrochemical cell for a lithium battery, comprising a positive electrode and a negative electrode separated from each other by an electrolyte consisting solely of at least one lithium salt and at least one compound selected from compounds of the cyclic ether family comprising at least one ring having an oxygen atom and at least one unsaturation.

### TECHNICAL FIELD

The present invention is directed towards an electrochemical cell for lithium battery, comprising a specific electrolyte, with which it is possible in particular to obtain very good electrochemical performances and more particularly strong cyclic charge retention, together with high first-cycle coulombic efficiency.

The general field of the invention can therefore be defined as concerning lithium batteries, and more specifically batteries of lithium-ion type.

Batteries of lithium-ion type are increasingly used as independent power sources notably in portable electronic equipment (such as mobile telephones, laptop computers, tooling) in which they are gradually replacing nickel-cadmium (NiCd) and nickel-metal hydride (NiMH) rechargeable batteries. They are also much used to power new micro-applications, such as smart cards, sensors or other electromechanical systems.

Lithium-ion batteries operate via an insertion-desinsertion process (or lithiation-delithiation) along the following principle.

When the battery discharges, the lithium extracted from the negative electrode in Li⁺ ionic form migrates through the ion-conducting electrolyte and comes to intercalate itself within the crystalline lattice of the active material of the positive electrode. The passing of each Li⁺ ion in the internal circuit of the battery is exactly offset by the passing of an electron in the external circuit, thereby generating an electric current. The specific energy density by mass released by these reactions is proportional both to the difference in potential between the two electrodes and to the amount of lithium that has intercalated in the active material of the positive electrode.

When the battery is charging, the reactions occurring within the battery are reverse reactions to discharge, namely:
the negative electrode inserts lithium in the lattice of its constituent material; and
the positive electrode releases lithium.

With this operating principle, batteries of lithium-ion type therefore require the presence of a material at the electrodes that is able to insert or extract lithium, but also requires an electrolyte allowing the conducting of lithium ions that is stable and allows very good electrochemical performance and more particularly strong cyclic charge retention together with high first-cycle coulombic efficiency.

The authors of the present invention have therefore set themselves this objective, in particular for batteries having a composite silicon-graphite material as active material.

### DESCRIPTION OF THE INVENTION

The invention therefore relates to an electrochemical cell for lithium battery comprising a positive electrode and a negative electrode, separated from each other by an electrolyte comprising at least one lithium salt and at least one compound selected from among the compounds of the cyclic ether family having at least one ring comprising an oxygen atom and at least one unsaturation. Advantageously, the electrolyte is composed solely of at least one compound from the cyclic ether family having at least one ring comprising an oxygen atom and at least one unsaturation, and at least one lithium salt.

The reasoned choice of the constituent ingredients of the above-mentioned electrolyte contributes towards obtaining very good electrochemical performances, and more particularly strong cycle charge retention together with high first-cycle coulombic efficiency.

As mentioned above, the electrolyte inter alia comprises at least one lithium salt.

The lithium salt can be selected from the group formed by LiPF₆, LiClO₄, LiBF₄, LiAsF₆, LiCF₃SO₃, lithium 4,5-dicyano-2-(trifluoromethyl)imidazolate (known under the abbreviation LiTDI), or from the sulfonylimide family such as lithium bis(trifluoromethylsulfonyl)imide (LiTFSI) LiN[SO₂CF₃]2, lithium bis(fluorosulfonyl)imide (known under the abbreviation LiFSI) LiN[SO₂F]₂, lithium 1,1,2,2,3,3-hexafluoropropane-1,3-disulfonylimide LiN[SO₂(CF₂)₃SO₂] and mixtures thereof, preference being given to the LiTFSI salt.

The lithium salt may be contained in the electrolyte in a concentration ranging from 0.1 M to 5 M, e.g. 1 M.

As mentioned above, the electrolyte comprises at least one compound selected from among the compounds of the cyclic ether family having at least one ring comprising an oxygen atom and at least one unsaturation, for example one unsaturation or two unsaturations, said compound conventionally meeting the function of organic solvent(s).

More specifically, according to a first embodiment, it may be a compound having a ring which, in addition to an oxygen atom, comprises 4 to 7 carbon atoms and has two unsaturations, and more specifically a compound having a ring comprising 4 carbon atoms and two unsaturations i.e. in other words a compound belonging to the family of furan compounds, for example meeting following formula (I):

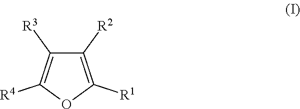

where R¹ to R⁴ are each independently a hydrogen atom or alkyl group.

In particular, specific compounds coming within those of formula (I) can be:
a compound where R¹ to R⁴ are a hydrogen atom, this compound therefore being represented by following formula (II):

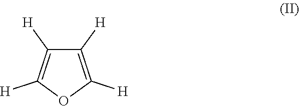

this compound being commonly designated as a furan;
a compound where one of R¹ to R⁴ is an alkyl group, whilst the others represent a hydrogen atom, one particular compound fulfilling this specificity being the compound meeting following formula (III):

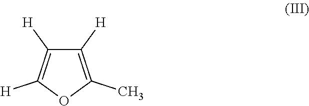

this compound being called 2-methylfuran.

In a second embodiment, the compound can be a compound having a ring which, in addition to an oxygen atom, comprises 3 to 7 carbon atoms and has one unsaturation, and more specifically a compound having a ring comprising 4 carbon atoms and one unsaturation.

More specifically, it may be a compound having a ring comprising 4 carbon atoms and one unsaturation meeting following formula (IV):

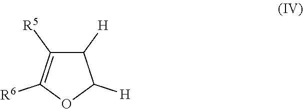

where R⁵ and R⁶ are each independently a hydrogen atom or alkyl group, and in particular where one of the groups R⁵ and R⁶ is an alkyl group whilst the other group is a hydrogen atom, one particular compound coming within this definition being the compound of following formula (V):

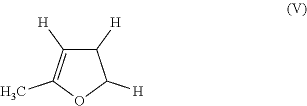

this compound being called 2,3-dihydro-5-methylfuran.

The electrolyte is advantageously composed solely of at least one cyclic ether compound having at least one ring comprising an oxygen atom, at least one unsaturation and at least one lithium salt allowing very good electrochemical performances to be obtained, and more specifically strong cyclic charge retention and high first-cycle coulombic efficiency.

Examples of specific electrolytes able to be included in the composition of the electrochemical cells of the invention are:
an electrolyte comprising furan (i.e. the compound of formula (II) such as defined above) and a LiTFSI lithium salt e.g. at a concentration of 1 mol·L⁻¹;
an electrolyte comprising 2-methylfuran (i.e. the compound of formula (III) such as defined above) and a LiTFSI lithium salt e.g. at a concentration of 1 mol·L⁻¹; or
an electrolyte comprising 2,3-dihydro-5-methylfuran (i.e. the compound of (V) such as defined above) and a LiTFSI lithium salt e.g. at a concentration of 1 mol·L⁻¹.

As mentioned in the foregoing, the electrochemical cells of the invention comprise a positive electrode and a negative electrode.

By positive electrode, in the foregoing and in the remainder hereof, it is conventionally meant the electrode acting as cathode when the generator is delivering current (i.e. when it is discharging) and acting as anode when the generator is charging.

By negative electrode, in the foregoing and in the remainder hereof, it is conventionally meant the electrode acting as anode when the generator is delivering current (i.e. when it is discharging) and acting as cathode when the generator is charging.

It is specified that each of the electrodes comprises an active material i.e. a material that is directly involved in lithium insertion and desinsertion reactions.

In addition to the presence of an active material, the electrode may comprise a polymeric binder such as polyvinylidene fluoride (known under the abbreviation PVDF), a mixture of carboxymethylcellulose (known under the abbreviation CMC) with a latex of styrene-butadiene type (known under the abbreviation SBR) or with polyacrylic acid (known under the abbreviation PAA) and one or more electricity-conducting additives which may be carbon materials such as carbon black.

Therefore, from a structural viewpoint, the electrode can be in the form of a composite material comprising a matrix of polymeric binder(s) in which fillers are dispersed composed of the active material and optionally the electricity-conducting additive(s).

This may particularly be the case when one of the electrodes, as active material, comprises a composite silicon-graphite material, this composite material possibly being contained in a proportion ranging from 50 to 95 weight % relative to the total weight of the electrode.

By silicon-graphite composite material, in the foregoing and in the remainder hereof, it is meant as is conventional a material comprising an aggregate of graphite particles and silicon particles, and in one particular embodiment aggregate silicon particles on graphite particles, the assembly being dispersed within a carbon matrix e.g. a disordered carbon matrix.

The electrode comprising a silicon-graphite composite material as active material can particularly be the positive electrode.

The negative electrode on the other hand, as active material, may comprise lithium metal, in which case the negative electrode can be in the form of lithium metal foil.

Finally, the invention relates to a lithium battery comprising one or more electrochemical cells such as defined above.

Other characteristics and advantages of the invention will become apparent from the following additional description referring to particular embodiments.

Evidently, this additional description is only given for illustration and does not in any manner limit the invention.

### BRIEF DESCRIPTION OF THE DRAWINGS

FIG. 1 is a graph illustrating the change in specific capacity C (in mAh/g) as a function of number of cycles N, for the electrochemical cell described in Example 1.

FIG. 2 is a graph illustrating the change in efficiency (i.e. the ratio of discharge specific capacity to charge specific capacity expressed in %) as a function of number of cycles N, for the cell described in Example 1.

FIG. 3 is a graph illustrating the change in specific capacity C (in mAh/g) as a function of number of cycles N, for the electrochemical cells described in Example 2.

FIG. 4 is a graph illustrating the change in efficiency (i.e. the ratio of discharge specific capacity to charge specific capacity expressed in %) as a function of number of cycles N, for the cells described in Example 2.

### DETAILED DESCRIPTION OF PARTICULAR EMBODIMENTS

### Example 1

The present example illustrates an electrochemical cell conforming to the invention, in the form of a button cell comprising:
as negative electrode, a negative electrode composed of lithium metal; and
as positive electrode, an electrode comprising a silicon-graphite composite as active material; and
an electrolyte arranged between said positive electrode and the negative electrode, the composition of which is explained below.

The negative electrode was obtained by cutting a disc 16 mm in diameter from lithium metal foil.

The positive electrode was obtained by coating a copper foil with an ink composed of 90 weight % silicon-graphite composite, 5 weight % electronic conductor (more specifically a mixture of Super P® grade carbon black and VGCF carbon fibres with 5 weight % of polymeric binder (more specifically a mixture of carboxymethylcellulose [250 000 g/mol] and polyacrylic acid [250 000 g/mol]). This electrode was calendered and cut into the form of a disc 14 mm in diameter.

The button cell was produced from these electrodes by stacking:
a disc of negative electrode;
disc of positive electrode; and
a separator composed of the superimposition of a disc in Viledon®, reference FS2207-25-DA WA (a membrane of nonwoven fibres of polyolefins (polypropylene/polyethylene)) and a disc in Celgard®, reference C2400 (a membrane in polypropylene), said separator being impregnated with an electrolyte.

The electrolyte comprised furan of formula (II) such as defined above, in which LiTFSI was dissolved at a concentration of 1 mol/L.

This cell was subjected to a galvanostatic cycling test whereby a first charge/discharge cycle between 1 V and 0.01 V was applied at a C/20 regime with a plateau at 0.01 V held until a current was reached corresponding to a C/100 regime, followed by a C/5 regime for the consecutive cycles with a plateau at 0.01 V held until a current was reached corresponding to a C/100 regime for each cycle.

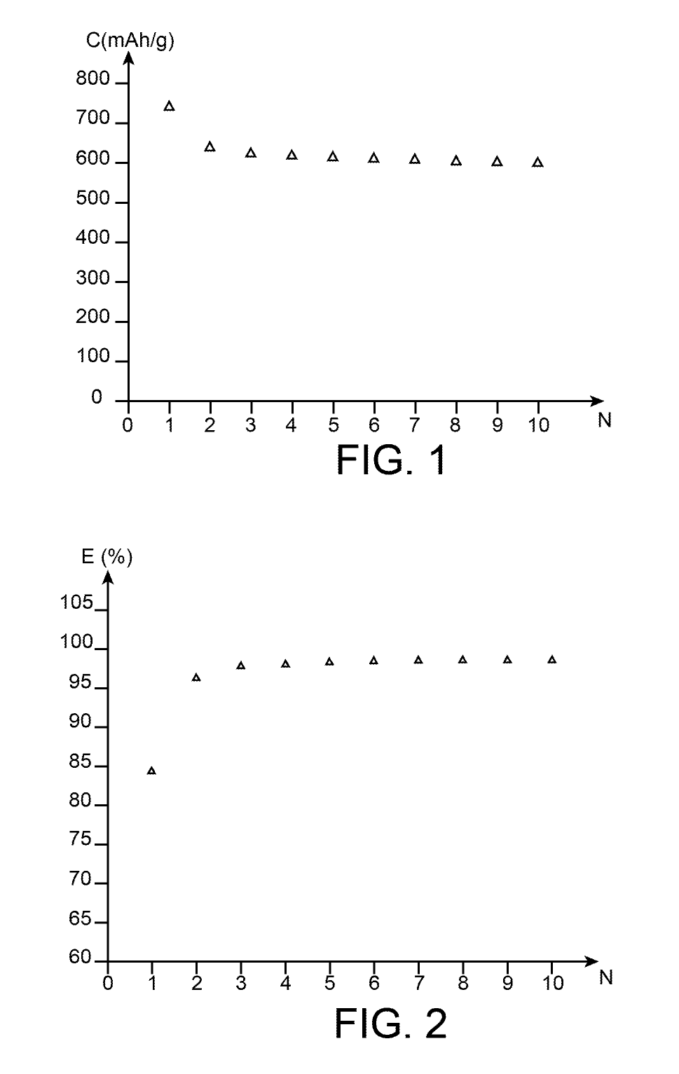

The results are given in FIG. 1 illustrating the change in specific capacity C (in mAh/g) as a function of number of cycles N, for the above-mentioned cell.

It can clearly be seen that the cell conforming to the invention has excellent cycling retention after 10 cycles.

In parallel, the efficiencies were also calculated i.e. the ratios of discharge capacities to charge capacities (expressed for the active material of the positive electrode) expressed in % as a function of number of cycles, the results being given in FIG. 2.

It can clearly be seen in the curve that the cell conforming to the invention has excellent first-cycle efficiency (higher than 80%) and at the following cycles (close to 100%).

### Example 2

This example illustrates electrochemical cells conforming to the invention, in the form of a button cell, comprising:
as negative electrode, a negative electrode composed of lithium metal; and
as positive electrode, an electrode comprising a silicon-graphite composite as active material; and
an electrolyte arranged between said positive electrode and the negative electrode, the composition of which is explained below.

The negative electrode was obtained by cutting a disc 16 mm in diameter from lithium metal foil.

The positive electrode was obtained by coating copper foil with an ink composed of 90 weight % of silicon-graphite composite, 5 weight % of electronic conductor (more specifically a mixture of Super P® grade carbon black and VGCF carbon fibres, with 5 weight % of polymeric binder (more specifically a mixture of carboxymethylcellulose (250 000 g/mol) and polyacrylic acid (250 000 g/mol). This electrode was calendered and cut into the form of a disc 14 mm in diameter.

The button cells were produced from these electrodes by stacking:
a disc of positive electrode;
a disc of negative electrode; and
a separator composed of a disc in Celgard®, reference C2400, (a membrane in polypropylene), said separator being impregnated with an electrolyte.

The cells conforming to the invention were the following:
a first cell comprising, as electrolyte, an electrolyte comprising furan in which LiTFSI was dissolved at a concentration of 1 mol/L;
a second cell comprising, as electrolyte, an electrolyte comprising 2-methylfuran, in which LiTFSI was dissolved at a concentration of 1 mol/L;
a third cell comprising, as electrolyte, an electrolyte comprising 2,3-dihydro-5-methylfuran, in which LiTFSI was dissolved at a concentration of 1 mol/L.

These different cells were subjected to a galvanostatic cycling test whereby a first charge/discharge cycle was applied between 3.7 V and 2 V, at a regime of C/20 with a plateau at 3.7 V held for 2 hours, followed by a C/10 regime with a plateau at 3.7 V held until a current corresponding to a C/50 regime was reached for the second cycle, and finally a C/5 regime for the consecutive cycles with a plateau at 3.7 V held until a current was reached corresponding to a C/50 regime for each cycle.

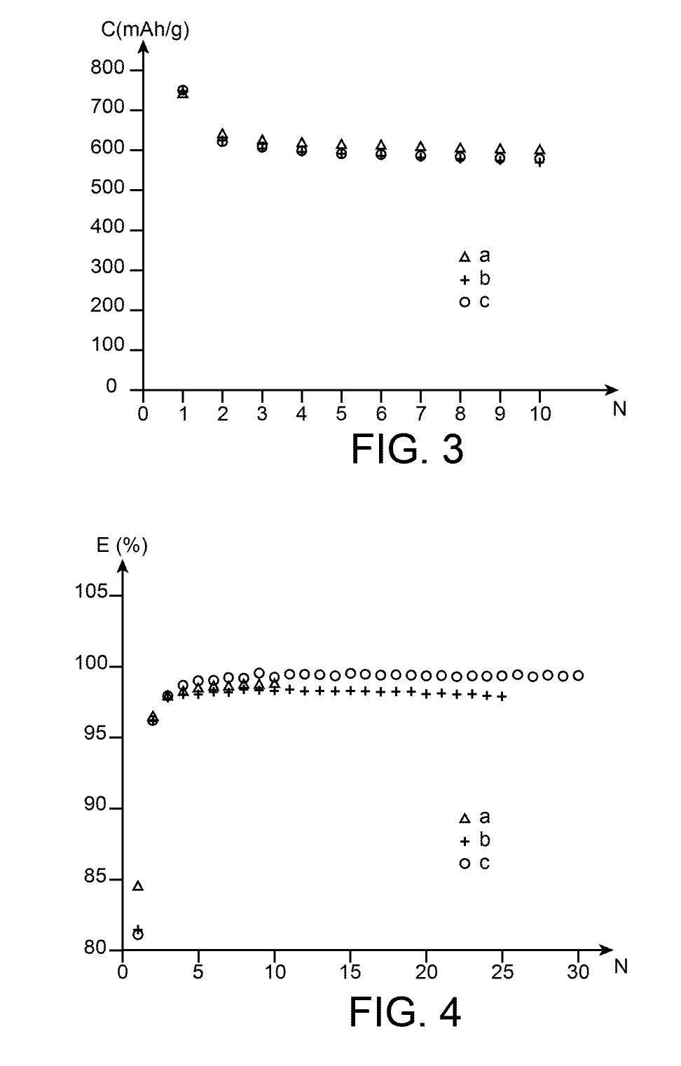

The results are given in FIG. 3 illustrating the change in initial specific capacity C (in mAh/g) as a function of number of cycles N, the curves being respectively referenced curve a) for the first above-mentioned cell to curve c) for the third above-mentioned cell.

It clearly follows from these curves that the cells conforming to the invention have excellent cycling retention (in the region of 100%) after more than about ten cycles.

In parallel the efficiencies were also determined i.e. the ratios of discharge capacities to charge capacities expressed in %, as a function of number of cycles, the results being given in FIG. 4 where the curves are respectively referenced curve a) for the first above-mentioned cell to curve c) for the third above-mentioned cell.

It clearly follows from these curves that the cells conforming to the invention have excellent first-cycle efficiency (higher than 80%) and at the following cycles (close to 100%).

1.-17. (canceled)

18. Electrochemical cell for lithium battery, comprising a positive electrode and a negative electrode separated from each by an electrolyte composed solely of at least one lithium salt and at least one compound selected from among the compounds of the cyclic ether family having at least one ring comprising an oxygen atom and at least one unsaturation.

19. The electrochemical cell according to claim 18, wherein the lithium salt is selected from the group formed by LiPF₆, LiClO₄, LiBF₄, LiAsF₆, LiCF₃SO₃, lithium 4,5-dicyano-2-(trifluoromethyl)imidazolate, or the sulfonylimide family such a lithium bis(trifluoromethylsulfonyl)imide LiN[SO₂CF₃]₂, lithium bis(fluorosulfonyl)imide LiN[SO₂F]₂, lithium 1,1,2,2,3,3-hexafluoropropane-1,3-disulfonylimide LiN[SO₂(CF₂)₃SO₂] and mixtures thereof.

20. The electrochemical cell according to claim 18, wherein the lithium salt is lithium bis(trifluoromethylsulfonyl)imide (LiTFSI).

21. The electrochemical cell according to claim 18, wherein the compound comprises a ring which, in addition to an oxygen atom, comprises 4 to 7 carbon atoms and has two unsaturations.

22. The electrochemical cell according to claim 18, wherein the compound comprises a ring having 4 carbon atoms and two unsaturations.

23. The electrochemical cell according to claim 18, wherein the compound meets following formula (I): 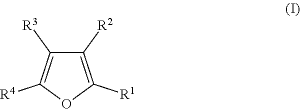
where R¹ to R⁴ are each independently a hydrogen atom or alkyl group.

24. The electrochemical cell according to claim 18, wherein the compound meets one of the following formulas (II) or (III):

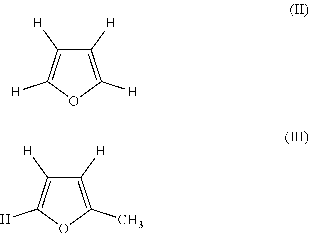

25. The electrochemical cell according to claim 18, wherein the compound comprises a ring which in, addition to an oxygen atom, comprises 3 to 7 carbon atoms and has one unsaturation.

26. The electrochemical cell according to claim 18, wherein the compound compromises a ring having 4 carbon atoms and one unsaturation.

27. The electrochemical cell according to claim 18, wherein the compound meets following formula (IV): 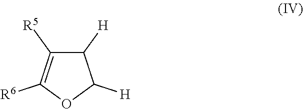
where R⁵ and R⁶ are each independently a hydrogen atom or alkyl group.

28. The electrochemical cell according to claim 27, wherein one of the groups R⁵ and R⁶ is an alkyl group whilst the other group is a hydrogen atom.

29. The electrochemical cell according to claim 18, wherein the compound meets following formula (V):

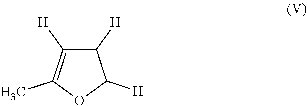

30. The electrochemical cell according to claim 18, wherein the electrolyte is:
an electrolyte comprising a furan (i.e. the compound of formula (II) such as defined in claim 7) and a LiTFSI lithium salt at a concentration of 1 mol·L⁻¹;
an electrolyte comprising 2-methylfuran (i.e. the compound of formula (III) such as defined in claim 7) and a LiTFSI lithium salt at a concentration of 1 mol·L⁻¹; or
an electrolyte comprising 2,3-dihydro-5-methylfuran (i.e. the compound of formula (V) such as defined in claim 12) and a LiTFSI lithium salt e.g. at a concentration of 1 mol·L⁻¹.

31. The electrochemical cell according to claim 18, wherein one of the electrodes, as active material, comprises a silicon-graphite composite material.

32. The electrochemical cell according to claim 18, wherein the positive electrode, as active material, comprises a silicon-graphite composite material.

33. The electrochemical cell according to claim 18, wherein the negative electrode, as active material, comprises lithium metal.

34. Lithium battery comprising one or more electrochemical cells such as defined in claim 18.
